(19) United States
(12) Patent Application Publication
(10) Pub. No.: US 2003/0130877 A1
(43) Pub. Date: Jul. 10, 2003

(54) Method and system for implementing total customer experience action planning

(76) Inventors: Christopher D. Farnes, Spokane, WA (US); Lynda D. Davis, Boise, ID (US); Ross A. Goodwin, Santa Rosa, CA (US); Thomas B. Rideout, Snohomish, WA (US)

Correspondence Address: HEWLETT-PACKARD COMPANY, Intellectual Property Administration, P.O. Box 272400, Fort Collins, CO, 80527-2400, US

(21) Appl. No.: 10/043,756

(22) Filed: Jan. 9, 2002

(51) Int. Cl. G06F 17/60

(52) U.S. Cl. 705/7

(57) ABSTRACT

One embodiment of the present invention provides large scale businesses and/or organizations a method for providing high customer value through a systematic approach of setting goals and strategies based on customers, partners and internal measures and linking these measures to implementation metrics. Specifically, total customer experience (TCE) strategic planning is a means to “opertionalize” efforts to provide a superior customer experience at the organization level, with success measured in terms of actual impact on customers. Through the TCE process, strategies and metrics are developed based on objective assessments of the organization's current TCE performance by customers, partners and internal sources rather than subjective introspection. This methodology begins by engaging organization leadership in a process that allows them to rapidly identify and focus on the “critical few” customer improvements required for their future business success.

### TECHNICAL FIELD

The present invention relates to the field of large scale business organizations. More specifically, the present invention relates to the field of enabling large scale business organizations to provide a superior total customer experience.

### BACKGROUND ART

There are many large scale business organizations that exist within the United States and throughout the world. Any one of these large scale business organizations may include several thousands or even hundreds of thousands of employees. Furthermore, the typical large scale business organization may include many different sub-organizations and departments that produce a wide variety of products and/or services. Additionally, the typical large scale business organization may have facilities and employees that are distributed in many different locations throughout a country or the world. It is appreciated that the typical large scale business organization provides many different benefits to their customers and local communities.

Notwithstanding these benefits, it is also understood that there are disadvantages associated with large scale business organizations. For example, given the sheer enormity of some large scale business organizations, they may have a difficult time determining whether they are providing a satisfactory level of service and/or products to their customers. Additionally, another disadvantage associated with a large scale business organization is that it may be more difficult to determine if changes within particular departments will actually improve their customers' overall experience. As such, there have been different solutions utilized in order to remedy some of the disadvantages associated with large scale business organizations.

For example, one solution for a large scale business organization has been to put together a council that included people from the front-end of a business organization that are responsible for the front facing activities of the business on its consumer side. This council has responsibility for looking across accumulated data (e.g., customer loyalty data, and the like) and determining what the highest priority areas of improvement should be for the entire business organization. Through this analysis of the data, the council determines what specific strategies and objectives to set for addressing the improvement needs. Subsequently, the council assigns the strategies and objectives to the specific departments which have responsibility over those areas in order for action to be taken on them.

However, there are disadvantages associated with this previously described council solution. For example, one of the disadvantages is that the leadership of the departments and/or sub-organizations that receive the council's strategies and objectives may not implement them. This result may be caused by the fact that the department's leadership did not have any input in setting these particular actions, yet they are expected to provide support and resources in order to get those things implemented. Basically, the council assumes that the leadership of the department and/or sub-organization will simply agree with their changes, strategies, and objectives and take action on them. Additionally, the implementation does not happen because the leadership of the department (or sub-organization) does not prioritize the improvement actions high enough against the department's other resource requirements.

Another solution for a large scale business organization involves process guidelines and tools that are used at a department level which focus on the overall customer experience associated with the business organization. Specifically, the leadership of each department provides an overview to their department of what this overall customer experience program is all about and the value it provides to the business organization. The leadership then has a discussion with its department about where they are at as a department in terms of addressing issues involved with the overall customer experience. The department tries to determine what its specific issues are as related to the overall customer experience. And ultimately, the department decides what could they do to have a positive impact on those issues as a department. The leadership is expected to document those discussions which should result in some strategy along with some description of their plans for accomplishing it.

However, there are disadvantages associated with this overall customer experience program. For example, it is easy for a department head who does not see much value in this program to avoid doing it properly. Specifically, a department head could fill out a form and check line items and have a staff meeting lasting about 10 to 15 minutes and sign off that the department had completed the requisite activities. In the case where there was more follow through by the department head, the outcome was typically a list that they thought they could do or should do. In the best case, there was someone assigned to have responsibility across departments of the organization and to actually gather the information associated with the department discussions and do some type of tracking of it. Additionally, in the best case there was actually some accountability in the form of at least periodic updates on progress. However, the person gathering and monitoring progress did not have any kind of responsibility for holding people accountable to it.

Another disadvantage associated with the overall customer experience program is that there it no way of determining for sure the actual state of the customer's overall experience associated with their business organization. Another disadvantages is that there is no way of knowing if the department has identified the critical issues and are taking action that will actually have an effect on improving the overall customer experience. Other shortcomings of the overall customer experience program are that it is very subjective and it lacks accountability. Furthermore, the extent to which the overall customer experience program is implemented within a department is based on the amount of value the department head and/or the department sees in it.

### DISCLOSURE OF THE INVENTION

Accordingly, a need exists for a method and system for providing a solution that is able to remedy some of the disadvantages associated with large scale business organizations. Specifically, a need exists for a method and system for enabling a large scale business organization to determine whether they are providing a satisfactory level of service and/or products to their customers. Furthermore, a need exists for a method and system that accomplishes the above mentioned need that is based on objectivity instead of subjectivity. Additionally, a need exists for a method and system that accomplishes the above mentioned needs and that also includes accountability for those involved with it. A need also exists for a method and system that accomplishes the above mentioned needs and will be properly implemented because leadership (e.g., organizational, departmental, and the like) is involved with it. Moreover, a need exists for a method and system that accomplishes the above mentioned needs and has the organization's leadership providing support and resources to those involved with it. The present invention provides a method and system which accomplishes the above mentioned needs.

For instance, one embodiment of the present invention provides large scale businesses and/or organizations a method for providing high customer value through a systematic approach of setting goals and strategies based on customers, partners and internal measures and linking these measures to implementation metrics. Specifically, total customer experience (TCE) strategic planning is a means to “opertionalize” efforts to provide a superior customer experience at the organization level, with success measured in terms of actual impact on customers. Through the TCE process, strategies and metrics are developed based on objective assessments of the organization's current TCE performance by customers, partners and internal sources rather than subjective introspection. This methodology begins by engaging organization leadership in a process that allows them to rapidly identify and focus on the “critical few” customer improvements required for their future business success. One of the focus of the TCE action planning process is on developing the organization's customer experience management capabilities as well as addressing critical customer loyalty and satisfaction issues.

In another embodiment, the present invention includes a computer readable medium having computer readable code embodied therein for causing a computer to perform particular actions. Specifically, the computer readable medium causes the computer to perform the action of receiving data associated with an organization and customers of the organization. Additionally, during a strategy session associated with the organization, the computer readable medium causes the computer to perform the action of receiving a goal for the organization along with an associated success metric for accomplishing the goal. It should be understood that the goal is based on the data. Moreover, the computer readable medium causes the computer to perform the action of receiving a department goal along with an associated success metric for accomplishing the department goal. It should be appreciated that the department goal is closely associated with a business objective of the organization. The computer readable medium also causes the computer to perform the action of receiving measurable action taken to accomplish the department goal.

In yet another embodiment, the present invention includes a computer system. The computer system includes a processor and an addressable data bus coupled to the processor. Furthermore, the computer system includes a memory device coupled to communicate with the processor for implementing a total customer experience action planning process. The method includes the particular actions described above in the previous paragraph.

These and other advantages of the present invention will no doubt become obvious to those of ordinary skill in the art after having read the following detailed description of the preferred embodiments which are illustrated in the drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram of an exemplary computer system used in accordance with an embodiment of the present invention.

FIG. 2 is a block diagram of an exemplary network used in accordance with an embodiment of the present invention.

FIG. 3 is a flowchart of steps performed in accordance with one embodiment of the present invention for implementing total customer experience (TCE) action planning.

FIG. 4 illustrates an exemplary recitation of the participation and responsibilities that may exist within the TCE action planning process in accordance with one embodiment of the present invention.

FIG. 5 is a block diagram illustrating an exemplary TCE delivery system in accordance with an embodiment of the present invention.

FIG. 6 illustrates an exemplary strategy session agenda of the TCE action planning process in accordance with an embodiment of the present invention.

FIG. 7 illustrates an exemplary action steps table in accordance with an embodiment of the present invention that may be utilized during the alignment session of the action planning process of the TCE action planning process.

### MODE(S) FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “verifying” or “gathering” or “determining” or “detecting” or “outputting” or “transmitting” or “taking” or “storing” or “receiving” or “recognizing” or “utilizing” or “generating” or “providing” or the like, may refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

### Exemplary Hardware in Accordance with the Present Invention

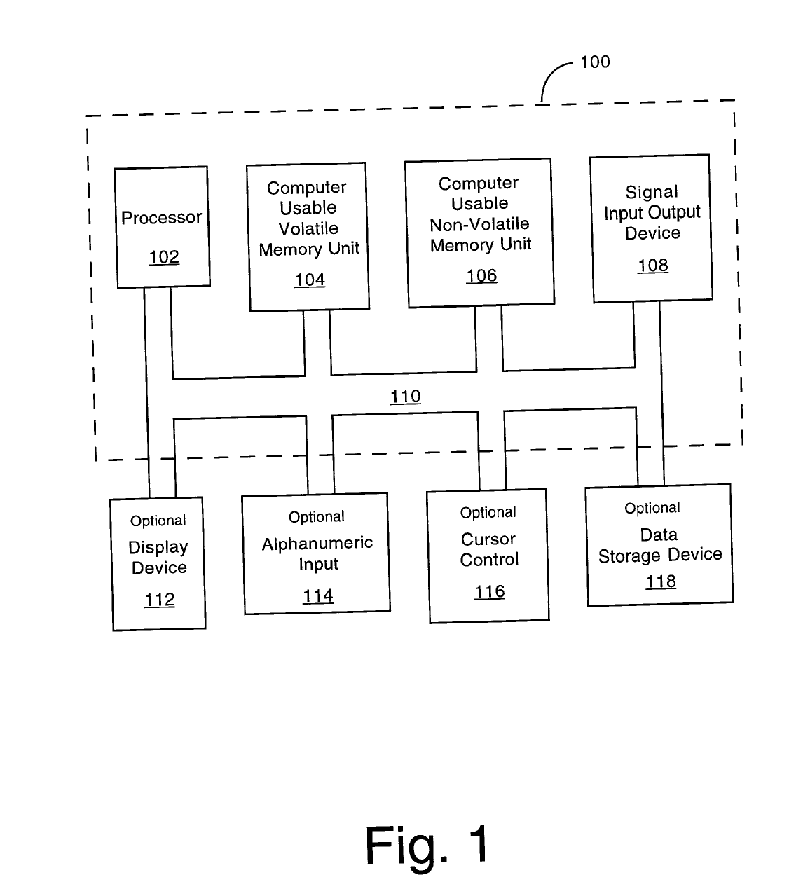

FIG. 1 is a block diagram of one embodiment of an exemplary computer system 100 used in accordance with the present invention. It should be appreciated that system 100 is not strictly limited to be a computer system. As such, system 100 of the present embodiment is well suited to be any type of computing device (e.g., server computer, portable computing device, desktop computer, etc.). Within the following discussions of the present invention, certain processes and steps are discussed that are realized, in one embodiment, as a series of instructions (e.g., software program) that reside within computer readable memory units of computer system 100 and executed by a processor(s) of system 100. When executed, the instructions cause computer 100 to perform specific actions and exhibit specific behavior which is described in detail below.

Computer system 100 of FIG. 1 comprises an address/data bus 110 for communicating information, one or more central processors 102 coupled with bus 110 for processing information and instructions. Central processor unit(s) 102 may be a microprocessor or any other type of processor. The computer 100 also includes data storage features such as a computer usable volatile memory unit 104 (e.g., random access memory, static RAM, dynamic RAM, etc.) coupled with bus 110 for storing information and instructions for central processor(s) 102, a computer usable non-volatile memory unit 106 (e.g., read only memory, programmable ROM, flash memory, EPROM, EEPROM, etc.) coupled with bus 110 for storing static information and instructions for processor(s) 102. System 100 also includes one or more signal generating and receiving devices 108 coupled with bus 110 for enabling system 100 to interface with other electronic devices and computer systems. The communication interface(s) 108 of the present embodiment may include wired and/or wireless communication technology. For example, within the present embodiment, the communication interface 108 is a serial communication port, but could also alternatively be any of a number of well known communication standards and protocols, e.g., Universal Serial Bus (USB), Ethernet, FireWire (IEEE 1394), parallel, small computer system interface (SCSI), infrared (IR) communication, Bluetooth wireless communication, broadband, and the like.

Optionally, computer system 100 may include an alphanumeric input device 114 including alphanumeric and function keys coupled to the bus 110 for communicating information and command selections to the central processor(s) 102. The computer 100 can include an optional cursor control or cursor directing device 116 coupled to the bus 110 for communicating user input information and command selections to the central processor(s) 102. The cursor directing device 116 can be implemented using a number of well known devices such as a mouse, a track-ball, a track-pad, an optical tracking device, a touch screen, etc. Alternatively, it is appreciated that a cursor can be directed and/or activated via input from the alphanumeric input device 114 using special keys and key sequence commands. The present embodiment is also well suited to directing a cursor by other means such as, for example, voice commands. The system 100 can also include a computer usable mass data storage device 118 such as a magnetic or optical disk and disk drive (e.g., hard drive or floppy diskette) coupled with bus 110 for storing information and instructions. An optional display device 112 is coupled to bus 110 of system 100 for displaying video and/or graphics. It should be appreciated that optional display device 112 may be a cathode ray tube (CRT), flat panel liquid crystal display (LCD), field emission display (FED), plasma display or any other display device suitable for displaying video and/or graphic images and alphanumeric characters recognizable to a user.

### Exemplary Network in Accordance with the Present Invention

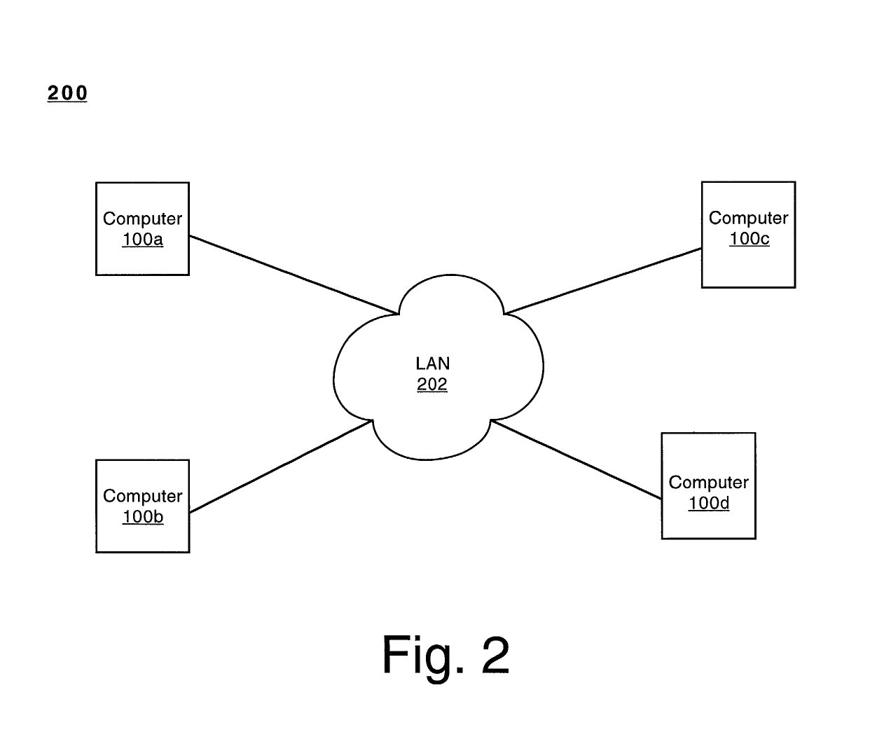

FIG. 2 is a block diagram of an exemplary network 200 used in accordance with an embodiment of the present invention. Within networking environment 200, the users of computer systems 100a, 100b, 100c and 100d may readily exchange files, share information stored on a common database, pool resources, and communicate via electronic mail (e-mail) and video teleconferencing. Specifically, network 200 includes computers 100a-100d which are each communicatively coupled to a local area network (LAN) 202. It should be appreciated that computers 100a-100d of the present embodiment are well suited to be communicatively coupled in a wide variety of implementations. For example, computers 100a-100d of network 200 may be coupled via coaxial cable, copper wire, fiber optics, wireless communication, and the like. Furthermore, computer systems 100a-100d of the present embodiment may also be communicatively coupled via a wide area network (WAN), e.g., the Internet.

Within network 200 of FIG. 2, it is understood that computers 100a-100d may each be implemented in a manner similar to computer system 100 of FIG. 1. Additionally, it should be appreciated that network 200 is well suited to have any number of computer systems (e.g., 100a-100d) communicatively coupled together. The computer systems 100a-100d of the present embodiment are well suited to be located within the same building, within different buildings of a company campus, or anywhere throughout the world.

### Exemplary Operations in Accordance with the Present Invention

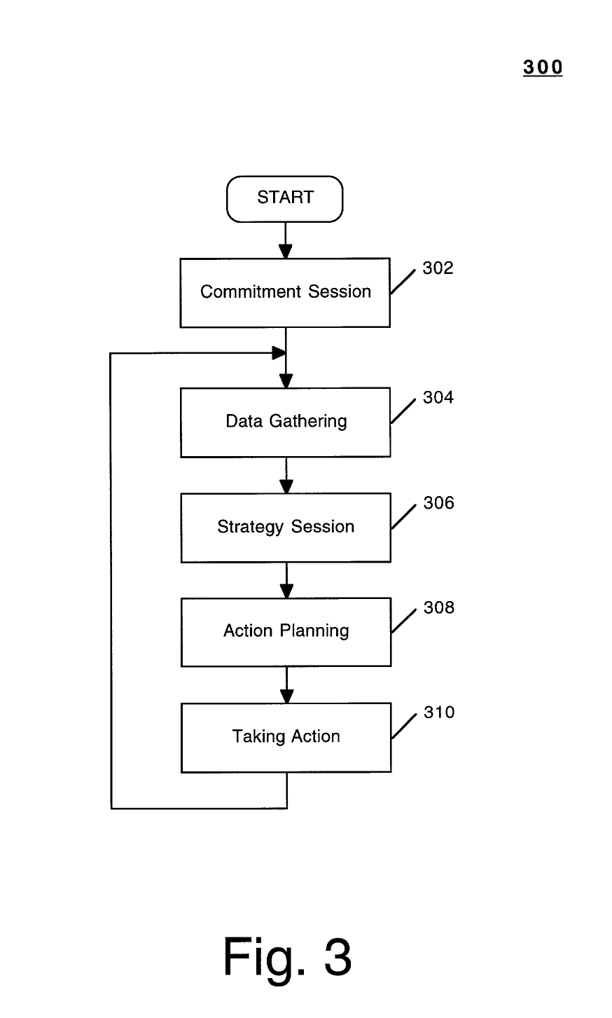

FIG. 3 is a flowchart 300 of steps performed in accordance with one embodiment of the present invention for implementing total customer experience (TCE) action planning. Flowchart 300 includes processes of the present invention which, in one embodiment, are carried out by processors and electrical components under the control of computer readable and computer executable instructions. The computer readable and computer executable instructions reside, for example, in data storage features such as computer usable volatile memory 104 and/or computer usable non-volatile memory 106 of FIG. 1. However, the computer readable and computer executable instructions may reside in any type of computer readable medium. Although specific steps are disclosed in flowchart 300, such steps are exemplary. That is, the present invention is well suited to performing various other steps or variations of the steps recited in FIG. 3. Within the present embodiment, it should be appreciated that the steps of flowchart 300 may be performed by humans, by software, by hardware or by any combination of humans, software and/or hardware.

The TCE action planning process of the present embodiment may be implemented within, but is not limited to, a large scale business organization at its sub-organization level. For example, a large scale business organization may have two or more different sub-organizations that each have a different business focus. Additionally, each sub-organization includes all of the associated business components for addressing their particular business focus. However, it is understood that the TCE action planning process may be implemented within any type of large scale organization or business.

The present embodiment provides large scale businesses and/or organizations a method for providing high customer value through a systematic approach of setting goals and strategies based on customers, partners and internal measures and linking these measures to implementation metrics. Specifically, total customer experience (TCE) strategic planning is a means to “opertionalize” efforts in order to provide a superior customer experience at the organization level wherein success is measured in terms of actual impact on customers. Through the TCE process, strategies and metrics are developed based on objective assessments of the organization's current TCE performance by customers, partners and internal sources rather than subjective introspection. This methodology begins by engaging organization leadership in a process that allows them to rapidly identify and focus on the “critical few” customer improvements required for their future business success. One of the focuses of the TCE action planning process is on developing the organization's management capabilities regarding all of the things which are performed within the organization that ultimately have an effect on the customer experience. Furthermore, another focus of TCE action planning is addressing critical customer loyalty and satisfaction issues.

The TCE action planning process of the present embodiment may provide many different advantages to an organization and/or business. For example, the TCE process specifically engages organization leadership in TCE improvement programs. Furthermore, the TCE planning process provides tops-down management and accountability of TCE improvement programs. Additionally, the TCE process provides continuous linkage from strategic goals and metrics to implementation of specific success metrics. Another advantage of the TCE process is that it provides management with the complete performance picture needed to identify and address the highest-return customer issues. Moreover, the TCE action planning provides a process for TCE delivery system partners to work together in order to set and align their strategies.

At step 302 of FIG. 3, within the present embodiment, a commitment session is conducted which is a meeting that provides an overview of the TCE action planning process by clarifying the objectives, sponsorship and importance of the program for the organization. For example, the participants of the commitment session are provided with a clear understanding of the process and deliverables, the roles they will play and what will be expected of them as they work to develop TCE as a core competency within the organization. Within the present embodiment of step 302, it should be understood that some of the main objectives of the commitment session are to clarify the TCE action planning process and establish the roles and expectations of the participates of this TCE process. Furthermore, within an embodiment of the present invention, the commitment session may be a meeting that last about an hour and a half. However, the commitment session of step 302 may last any amount of time.

Specifically, the commitment session of step 302 may involve the general managers and their immediate staff of the organization or business. It should be appreciated that before the commitment session of step 302, someone who is familiar with the TCE action planning process of flowchart 300 may have met at least once with the general managers in order to position this process with them and make sure that they understand what it is all about and what actions they are committing themselves, their staff, and the organization to perform. The commitment session of step 302 is the first time that the teams of the general managers are pulled together in order to introduce them to the TCE action planning process. One of the objectives of the commitment session is to make sure they understand what the TCE process is and the outcomes of it. Another objective of the commitment session is to make sure that they understand what the expectations are for them and that they are dedicated to participate in the process.

During the commitment session of step 302 of FIG. 3 there is a verification between what the organization's business objectives are and what they need for their future success along with what the TCE process is able to provide their organization. This may be done by having the general managers lead off by talking about what their business objectives are and why providing a superior customer experience is important in achieving those objectives. Additionally, within the organization there may be a TCE manager (or specialist). If there is a TCE manager, he or she is also utilized to help the team understand how this TCE action planning process of flowchart 300 will move them toward their business objectives and also how it fits into any other TCE related initiatives or work that they have going on within the organization.

Furthermore, during the commitment session of step 302, the roles and responsibilities of the participates of the TCE action planning process are explained. Specifically, this is when it is made clear to those people participating in the commitment session that they are filling the role of what is referred to as TCE strategists for the organization. As such, the requirements for them are to participate in an upcoming strategy session (e.g., at step 306), complete some surveys, and then take responsibility for holding future goal owners (that they will charter to go off and implement these goals) accountable in terms of the metrics that they set for them.

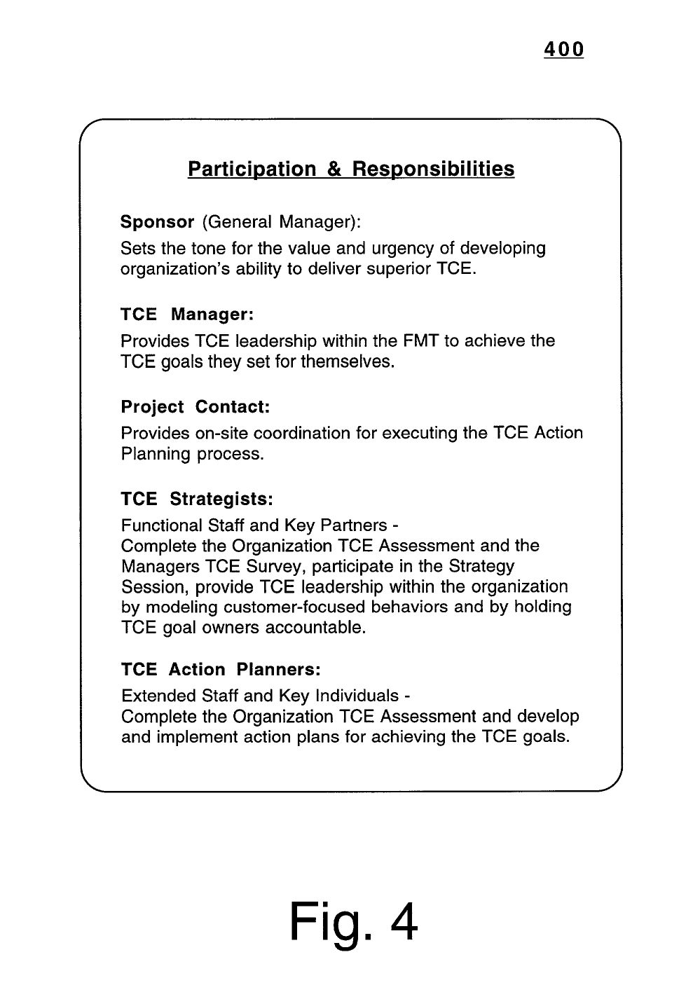

FIG. 4 is an exemplary participation and responsibilities list 400 that corresponds with the participates of the TCE action planning process 300 in accordance with an embodiment of the present invention. It should be appreciated that the participation and responsibilities list 400 may be utilized during the commitment session of step 302 in order to inform the participates of their responsibilities associated with the TCE action planning process 300. For example, the participation and responsibilities list 400 may be implemented as a slide so that its information may be projected enabling all of the participates to view it. Additionally, the participation and responsibilities list 400 may printed on separate sheets of paper which may be distributed to each participate involved in the commitment session of step 302. Moreover, the participation and responsibilities list 400 may be distributed electronically (e.g., via e-mail, video teleconferencing, and the like) to participates of the commitment session of step 302.

The participation and responsibilities list 400 of the present embodiment lists the various participates of the TCE action planning process 300 along with a summary of their responsibilities. Specifically, a sponsor is listed which may be a general manager of the organization. However, it is understood that the sponsor of the TCE action planning process 300 may be any upper level leader within the organization. As shown within the participation and responsibilities list 400, the responsibilities of the sponsor is to set the tone for the value and urgency of developing the organization's ability to deliver superior TCE. Furthermore, a TCE manger is listed as having the responsibility of providing TCE leadership within the functional management team (FMT) to achieve the TCE goals they set for themselves. There is also a project contact that provides on-site coordination for executing the TCE action planning process 300. The participation and responsibilities list 400 also includes the TCE strategists which may include the functional staff and key partners. It is the responsibilities of the TCE strategists to complete the organization TCE assessment and the manager's TCE survey, participate in the strategy session (of step 306), provide TCE leadership within the organization by modeling customer-focused behaviors and by holding TCE goal owners accountable. The TCE action planners are also listed which may include extended staff and key individuals. The responsibilities of the TCE action planners may include completing the organization TCE assessment and developing and implementing action plans for achieving the TCE goals.

After the participates of the commitment session of step 302 of FIG. 3 understand what the TCE action planning process 300 is all about, any additionally participants are identified (e.g., front-end, back-end, partners, and the like) that may be useful to involve within the TCE action planning process 300. The identity of additional participants may be performed in a wide variety of ways in accordance with the present embodiment. For example, the participates of the commitment session may be queried as to whether there is anybody else outside of the organization that they would like to include as a TCE strategist. In this manner, key partners may be included within the TCE process 300 in order to help identify the goals that particular departments or the organization may need to set and take action on to achieve. One of the reasons for doing this with organizations that are very large is that there is a lot of interaction and codependence across different organizations and departments.

For example, it may make sense for a key marketing person from the front-end who is particularly involved or familiar with the customers of a specific back-end unit to be included as a TCE strategist within the TCE action planning process 300. By including these other people from different departments of the organization, they may provide input into the TCE process 300. Moreover, as goals are identified and set during the TCE process 300 in order to achieve a superior customer experience, they may be goals that require work outside or beyond the organization. As such, those people are there who understand how to set those goals and/or are the people who may become goal owners or may directly charter goal owners for achieving those goals.

It is understood that the commitment session of step 302 may be performed utilizing a computer (e.g., 100a) and/or other computers (e.g., 100b-100d) via a network (e.g., 200). For example, a video teleconferencing of the commitment session of step 302 may be conducted via network 200 in order to include remote general managers and their team members that are unable to meet at a particular location. Moreover, within another embodiment, data and information associated with the commitment session of step 302 may be transmitted (e.g., via electronic mail) to general managers and their team members that are unable to attend the commitment session of step 302.

At step 304 of FIG. 3, within the present embodiment, a data gathering process is performed where data associated with customer loyalty, satisfaction and their total customer experience (TCE) are gathered. Furthermore, during step 304, the TCE performance of major competitors of the business organization is also researched. During the data gathering process, participants within the organization complete a questionnaire assessing the organization's current performance in the areas critical to their TCE success. Moreover, the organization's key partners for providing TCE are also surveyed during the data gathering process of step 304. It should be appreciated that the data from these surveys are analyzed and presented during an upcoming strategy session (e.g., at step 306) in order to focus the discussions of the critical TCE improvement opportunities.

Specifically, during the data gathering of step 304, data may be acquired associated with existing organization data (e.g., business and TCE strategies, customer data, etc.). Furthermore, during the data gathering process data may be acquired regarding customer feedback on TCE performance, loyalty and satisfaction levels. Research is also performed during the data gathering process on what competitors are doing in order to provide a superior TCE (if such is the case). Also during step 304, feedback data may be acquired from key partners of the organization regarding the organization's TCE performance. Moreover, the data gathering process may include acquiring feedback from within the organization on current TCE performance along with future needs of the organization. Within the present embodiment of step 304, it should be understood that some of the objectives of the data gathering process may be to assess current performance of the business organization and identify future needs for its success.

More specifically, one of the focuses of the data gathering process of step 304 of FIG. 3 is to pull together different perspectives in order to more fully understand and characterize the organization's current performance so that the TCE strategists are more easily able to identify what their critical improvement needs are within their departments and/or sub-organizations. As such, the data gathering process may include acquiring feedback from their customers about their current performance across the customer experience life cycle and also feedback from the customers on how the organization is doing relative to their competitors. It should be appreciated that the customer experience life cycle refers to a customer's experience that begins with understanding who the organization (or business), to understanding what the product (and/or service) is, to ordering, to getting the product, to living with and using the product, through the final disposal of the product. As such, the data gathering process also involves acquiring feedback from their customers about the relative priority of these different life cycle components in determining the customer's satisfaction and loyalty. Furthermore, the data gathering process may involve receiving feedback from the organization's key partners as to how well the organization is able to work with them in order to provide a superior TCE.

The data gathering process of step 304 also may include receiving insight and/or feedback from within the organization at its various levels and across its various departments as to what they are doing and what their current perceptions are about the organization's capabilities and performance. Additionally, the data gathering may also include surveying the managers and the TCE strategists within the organization in order to receive their current perception or beliefs about what the customer's priorities and needs are with regard to the organization. One of the reasons for gathering this last set of data is to be able to assess what is really going on with the customers of the organization compared to what the managers and the TCE strategists believe is going on with their customers.

The data gathering process of step 304 of FIG. 3 may take about 3 to 4 weeks after the completion of the commitment session of step 302. It should be understood that a separate group that is familiar with the TCE process 300 may be gathering the data and analyzing it. That is, the team of TCE strategists (with the exception of the TCE manager) are not participating in the data gathering process except for filling out assessments and the like. Once all of the desired data has been acquired, the data gathering process includes an analysis of it in order to draw conclusions and insight from it. One of the purposes of the data gathering process of step 304 is to provide conclusions and insight about the organization's TCE performance during the upcoming strategy session (at step 306) in order to focus the discussion on the critical areas of TCE improvement opportunities. There are many different ways in accordance with the present embodiment to draw conclusions and insight from the gathered data.

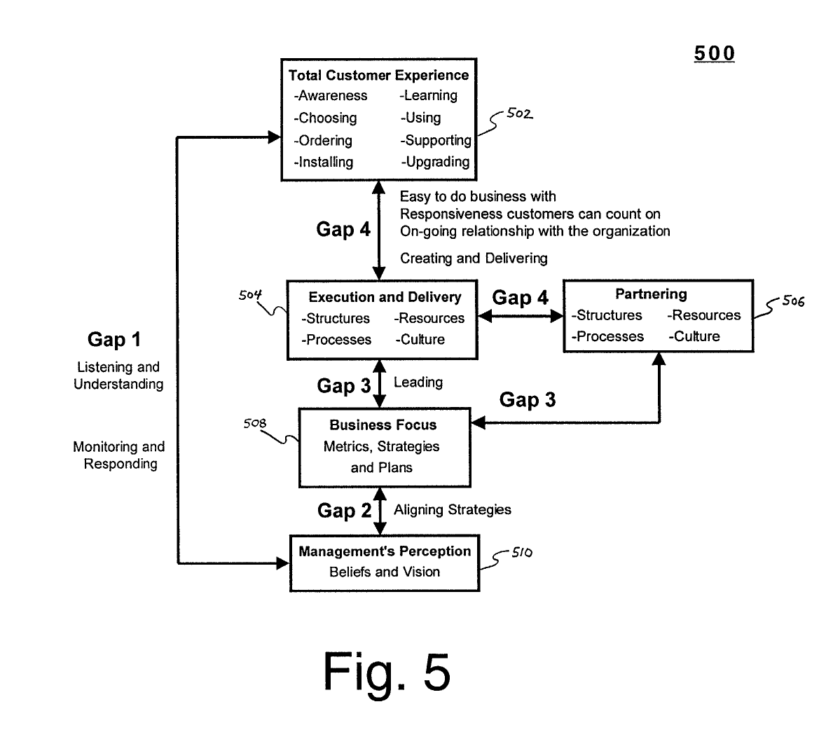

For example, FIG. 5 illustrates an exemplary TCE delivery system 500 which is an organizational block diagram in accordance with one embodiment of the present invention. The TCE delivery system 500 may be utilized in order to analyze the gaps which exist between the different organizational blocks of the business organization. Within the present embodiment, the TCE delivery system 500 defines four different areas within the organization that provide the delivery system for the TCE. As such, by understanding the different areas within the TCE delivery system 500 and the association between them, the organization is more able to provide a superior TCE. Specifically, the TCE delivery system 500 includes a total customer experience (TCE) block 502 which is coupled to a management's perception block 510 and an execution and delivery block 504. The management's perception block 510 is coupled to a business focus block 508 which is coupled to an optional partnering block 506 and the execution and delivery block 504.

Each of the blocks of the TCE delivery system 500 are defined within the present embodiment. For example, the TCE block 502 delineates that the TCE may include providing an awareness of the organization and its products to its potential customers. The TCE block 502 also includes the customer choosing and ordering one or more of the organization's products and subsequently installing the product, learning more about the product, and using it. The TCE 502 may also include the organization's ability to provide customer support and upgrades for their products. Another organizational block within the TCE delivery system 500 is the management's perception block 510 which includes the beliefs and vision of the organization's management. Additionally, there is the business focus block 508 which includes the metrics, strategies and plans for the organization's business. Furthermore, the execution and delivery block 504 and partnering block 506 may each include the structures, processes, resources and culture of the organization that is associated with the TCE.

When doing a gap analysis utilizing the TCE delivery system 500 of FIG. 5, it should be understood that what happens between the different organizational blocks directly affects the organization's successfulness in providing a superior TCE. Specifically, gap 1 between the TCE block 502 and the management's perception block 510 indicates that the managers should listen and understand the TCE by monitoring and responding to the TCE. On the other hand, Gap 2 indicates that the strategies of the management's perception 510 and the business focus 508 should be aligned in order to improve the TCE. Gap 3 indicates that the business focus 508 should be leading both the partnering block 506 and the execution and delivery block 504. While gap 4 indicates that the execution and delivery block 504 and the partnering block 506 should be easy to do business with, provide responsiveness that customers can count on, and enable customers to have an on-going relationship with the organization. Furthermore, gap 4 also includes creating and delivering the organization's products or services to their customers. It should be understood that if the organization is able to manage gaps 1-4 well, that it will be able to provide a superior TCE. Therefore, managing gaps 1-4 should be important to the organization.

It is appreciated that any data gathering (e.g., step 304) associated with the TCE action planning process 300 may be performed utilizing a computer (e.g., 100a) and/or other computers (e.g., 100b-100d) via a network (e.g., 200). For example, one or more questionnaires or surveys may be distributed to people within and outside of the organization and returned in order to collect data pertaining to the TCE associated with the organization. Within one embodiment of the present invention, surveys and/or questionnaires may be distributed via electronic mail (e-mail) to different groups of people and returned in a similar manner.

It should be noted that some data gathering may be performed even before the commitment session of step 302 of FIG. 3. For example, those that are familiar with the TCE action planning process 300 may have been working with the TCE manager of the organization and/or with one or more general managers who may have identified a need for the organization to utilize the TCE process 300. As such, between the time the organization indicates that it would like to participate in the TCE action planning process 300 and the commitment session of step 302, there is time to pull together pertinent data that already exists within the organization. For example, the data may include current data about the organization's competitors, their customers, and their business objectives which may be utilized to determine what other data may need to gathered during the TCE action planning process 300. That is, the existing data may be utilized to define and design the data gathering that may or may not need to take place during the data gathering process of step 304.

At step 306 of FIG. 3, within the present embodiment, a strategy session is conducted in order to identify which aspects of the customer focus are most critical to their business success and discussing the organization's current performance in these areas. It should be appreciated that the strategy session of step 306 may involve the TCE strategy group which may include the general manager and his or her immediate staff and other partners that they may want to bring in. Additionally, within an embodiment of the present invention, the strategy session may be conducted as a one day workshop. Furthermore, the outcome of the strategy session of step 306 should be a shared understanding of the key customer experience management (CEM) capabilities for providing superior TCE and clearly identified goals and goal owners for addressing the organization's most critical improvement needs and customer issues. Within the present embodiment of step 306, the objectives of the strategy session process may be to focus on critical issues of the organization, set TCE goals, identify goal owners, and kick-off the action planning process of step 308.

Specifically, during the strategy session of step 306 there may be a presentation and discussion about the customer feedback regarding the organization's TCE performance along with the customer loyalty hot spots. Furthermore, there may be a presentation and discussion associated with the key partner feedback on the organization's TCE performance. The strategy session of step 306 may also include a presentation and discussion regarding the organization's performance with key TCE capabilities. During the strategy session, those that are participating are able to select the highest leverage improvement areas and set goals associated with those improvement areas. Additionally, during the strategy session of step 306 specific goals are assigned to specific TCE goal owners and an action planning process of step 308 is also introduced.

More specifically, during the strategy session of step 306 of FIG. 3, the highlights of the data gathering of step 304 are presented and discussed along with what was learned from the gathered data about the TCE associated with the organization. As part of the strategy session, there may be areas where suggestions are solicited as to what should be done to improve certain situations. In essence, there is a brainstorming session conducted for soliciting strategies that could be implemented in order to address a particular issue. This process is repeated for each of the different issues that are particular to the shortcomings of the TCE performance of the organization.

Furthermore, once all of the strategies and solutions are received during the strategy session of step 306, then the group of TCE strategists (e.g., general managers and their team members) are questioned as to which ones of these strategies and/or solutions may be the “critical few” things that would make the most sense for the organization to focus on accomplishing in order to provide the greatest improvement of the organization's TCE. For example, one way for assisting the group to determine the “critical few” things is to discuss the organization's business objectives and their future needs. Then these business objectives and their future needs are positioned against the possible strategies and/or solutions in order to determine what really makes sense for the organization to implement as their future goals. In other words, the participates of the strategy session are directed to select the highest leverage improvement areas and set goals associated with those areas. That is, the participates are queried as to where can they make significant improvements and where those improvements will have the most significant impact on their business goals.

It should be pointed out that it is important that there is alignment between the TCE goals that are set during the strategy session of step 306 of FIG. 3 and the business goals of the organization. As such, there should be a direct connection between the TCE goals that are set and the business goals of the organization. One of the benefits of having this direct connection is that it provides justification for applying resources and funding of the organization to the TCE action planning process 300. It is appreciated that within the typical large scale organization, the managers and their teams are measured by how well they are able to meet the business goals of the organization. Therefore, it is important that the TCE goals are aligned with the business goals of the organization. Moreover, it makes it easier for those people who are chartered to actually fulfill the TCE goals to actual see how these goals contribute to accomplishing the other things that they are typically measured on within the organization. That is, the goals of the TCE action planning process 300 are complementary with the business goals that (for instance) lower level managers, extended management teams and so forth know that their performance is going to be measured against.

Once the particular goals have been identified during the strategy session of step 306 that are going to be pursued, the next thing is to identify an individual who is going to be the owner of each of the goals. It is understood that a goal owner may be chosen from any of those participating in the strategy session of step 306 or may be chosen from people within or outside of the organization. Once the goal owners have been determined, the TCE strategy group identify the success criteria associated with each of the goals. For example, it may be determined how each goal will be measured and what its acceptable level of performance will be. Within another embodiment, a measurable target goal may be set along with a minimal acceptable level of performance associated with that goal.

It is understood that the strategy session of step 306 of FIG. 3 may be performed utilizing a computer (e.g., 100a) and/or other computers (e.g., 100b-100d) via a network (e.g., 200). For example, a video teleconferencing of the strategy session of step 306 may be conducted via network 200 in order to include remote general managers and their team members that may be unable to meet at a particular location. Additionally, within another embodiment of the present invention, data and information associated with the strategy session process of step 306 may be transmitted (e.g., via e-mail) to general managers and their team members that are unable to attend this strategy session.

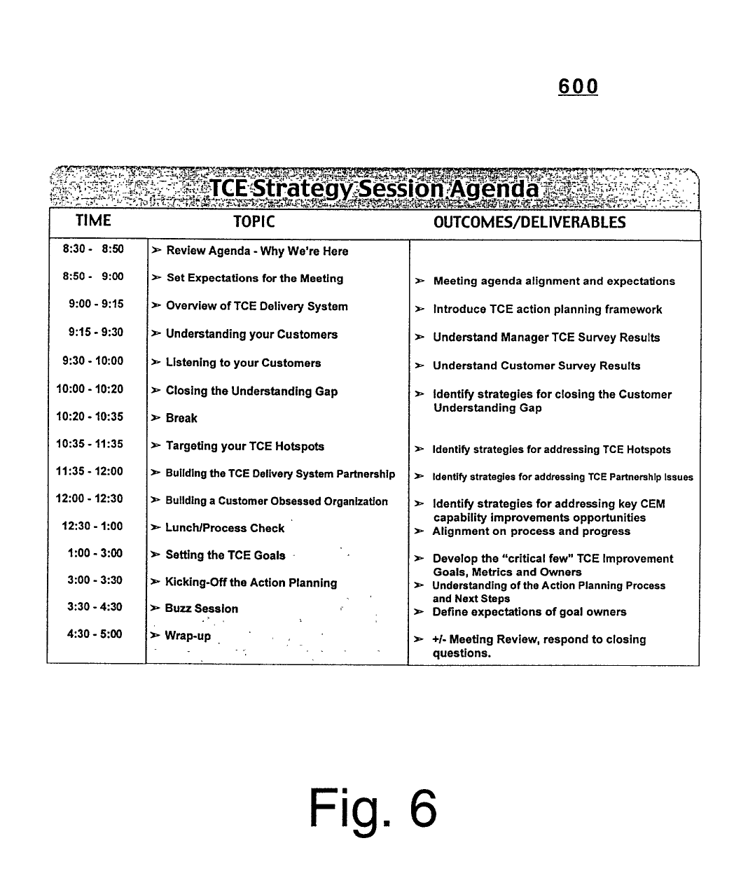

The strategy session of step 306 may be implemented in a wide variety of ways in accordance with the present embodiment. For example, FIG. 6 illustrates an exemplary strategy session agenda 600 in accordance with an embodiment of the present invention that may be incorporated during step 306. The strategy session agenda 600 includes a time frame for discussing different topics along with their corresponding outcomes/deliverables of the strategy session of step 306.

Specifically, the first topic of discussion shown within the strategy session agenda 600 of FIG. 6 is to provide an overall review of agenda 600 in order to inform participates why they are attending the strategy session. The second topic of agenda 600 is to “set expectations for the meeting” wherein the outcome is to understand the meeting agenda alignment and expectations of its participates. The next topic of agenda 600 is an “overview discussion of the TCE delivery system” (described herein) which provides an introduction to the TCE action planning framework. Additionally, the topic of “understanding your customers” is shown within agenda 600 which provides the participates an understanding about the results of the manager TCE survey. Furthermore, the topic of “listening to your customers” is part of agenda 600 wherein the customer survey results are presented and discussed. An additional topic is “closing the understanding gap” which includes the identification of strategies for closing the customer understanding gap.

Another topic included within the strategy session agenda 600 of FIG. 6 is “targeting your TCE hotspots” which provides specific strategies for addressing the TCE hotspots. Moreover, the agenda 600 includes the topic of “building the TCE delivery system partnership” which provides specific strategies for addressing TCE partnership issues. Another topic of agenda 600 is “building a customer obsessed organization” which provides strategies for addressing key customer experience management (CEM) capability improvement opportunities. And during the topic of “process check” an alignment is established with the process and progress of the strategies. Furthermore, the agenda 600 includes the topic of “setting the TCE goals” which includes developing the “critical few” TCE improvement goals along with their corresponding success metrics and the identity of the goal owners. The next topic of agenda 600 is “kicking-off the action planning” which provides the participates an understanding of the action planning process (of step 308) along with the next steps that will be involved with the TCE process 300. The agenda 600 also includes a “buzz session” topic where the expectations of the goal owners are defined by the participates of the strategy session of step 306. And finally, there is a “wrap-up ” topic of agenda 600 where the participates may review the strategy session meeting along with time being allocated for questions to be answered before ending the strategy session of step 306.

In step 308 of FIG. 3, within the present embodiment, the action planning process is conducted wherein each TCE goal owner is facilitated as needed through the process of leading extended staff and key individuals in setting appropriate action plans for achieving goals. That is, each action plan, success criteria and measurement methods are defined for tracking progress toward the goal. Once these action plans have been established, they are reviewed and approved during a sub-process referred to as an alignment session. It should be understood that within the present embodiment of step 308, some of the objectives of the action planning process may be to focus on validating the TCE goals and developing action plans and success criteria associated with these action plans.

Specifically, during the action planning of step 308, there may be a validation of the TCE improvement goals with upper management. Furthermore, during the action planning process there may be a development of action plans and success criteria for making the strategy, structure, measures and culture improvements needed within the organization. Additionally, the action planning process includes reviewing the alignment and completeness of the action plans for achieving the goals.

During the action planning process of step 308 of FIG. 3, the goal owners pull together their extended staff and/or any other key individuals who they think may need to be involved in accomplishing the goals. Also during the action planning of step 308, the general managers are responsible for taking their set of goals, success criteria, and names of the goal owners and verifying or validating all of these things with their up-line managers. One of the reasons for doing this is to keep the up-line managers informed as to the actions of those individuals they are overseeing. Another reason for doing this verifying is to be able to report back to all of the goal owners that it has been done and that the up-line managers believe that these actions are the right things for them to be implementing. It should be noted that it may be important to the organization that this verifying or validating with the up-line managers be performed before expending anymore resources and/or funding in order to insure that the TCE action planning process 300 is not in some way misdirected.

Additionally, during the action planning process of step 308, the goal owners (or action owners) meet with their teams. One of the first things they do during this meeting is to put together a set of local level plans that they believe are necessary in order to implement this goal along with its success criteria. The success criteria is what the team will be utilizing within their project in order to track their progress and measure whether they have achieved the goal. Once these plans, goals and success criteria have been established, the goal owners bring those action plans to an alignment session that involves the other TCE strategist teams.

Specifically, during the alignment session of the action planning process of step 308 of FIG. 3, the goal owners bring those action plans where they are reviewed with the rest of the TCE strategist teams to make sure that they are appropriate and sufficient. Another reason for the alignment session is to give the TCE strategy team a chance to look for opportunities to converge or leverage any of these different action plans. Also during the alignment session the strategy team may realize that the goals may take more resources than they thought and that it may be better to stagger them in time by doing a particular one or more first in time and then others later. It is also during the alignment session of the action planning process of step 308 that the TCE strategy team commits the resources (and the like) in order to move forward with the action plans. At this point, the goal owners and their teams are able to begin their implementation of the action goals. Therefore, at the end of the alignment session, the goal owners now know that the determined actions resulting from this session are their plan for action and that the needed resources are available to them.

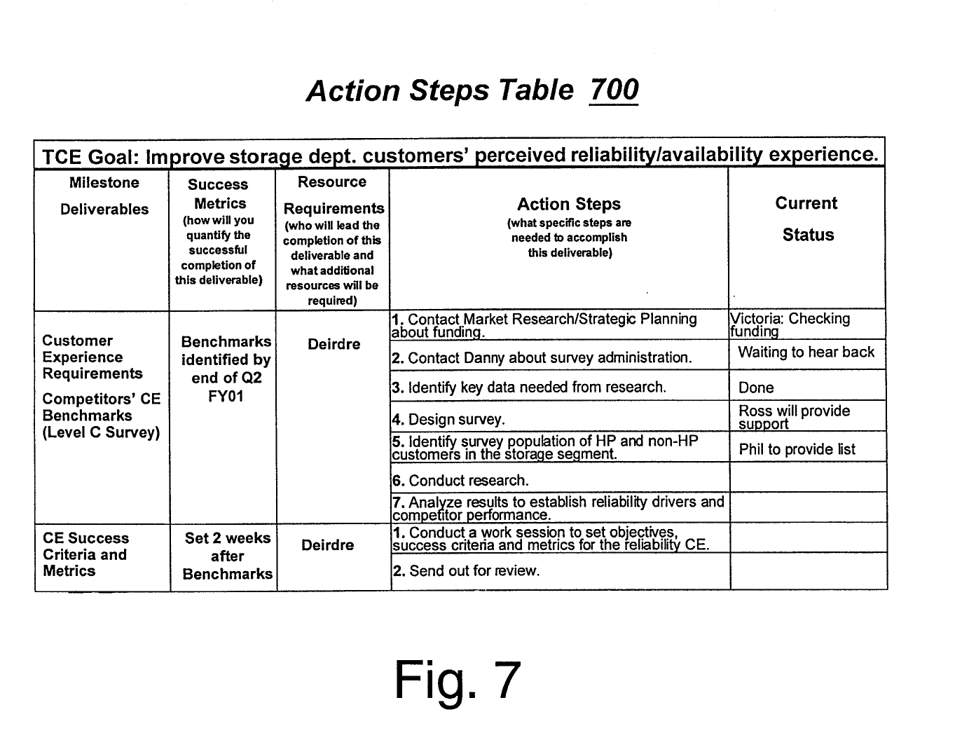

It is appreciated that many different items may be reviewed during the alignment session of the action planning process of step 308. For example, FIG. 7 illustrates an exemplary action steps table 700 in accordance with an embodiment of the present invention that may be utilized during the alignment session of the action planning process of step 308. Specifically, the action steps table 700 includes an area for including the overall TCE goal of a department (e.g., storage) of the organization. Additionally, the action steps table 700 includes areas for filling out the specific action plans of the department during the alignment session. That is, the action steps table 700 includes a milestone deliverables column, a success metrics column, a resource requirements column, an action steps column, and a current status column. By filling out the different columns of the action steps table 700, the department is able to have tangible plans for accomplishing their TCE goal.

For example, the milestone deliverable column of the action steps table 700 is where the specific deliverables are listed that need to be accomplished by the department. Additionally, the success metrics column is where the goal owners fill out how they will quantify the successful completion of each deliverable listed under the milestone deliverables column. The resource requirements column is where the person is listed who will lead the completion of each deliverable listed under the milestone deliverables column and what additional resources will be required to do so. Underneath the action steps column is listed the specific steps that are needed to accomplish each deliverable listed under the milestone deliverables column. Furthermore, underneath the current status column is listed the status and (as needed) the person involved with the current status of each deliverable listed under the milestone deliverables column. As such, the action steps table 700 may be utilized during the alignment session of the action planning process of step 308 such that the action plans of the goal owners may be reviewed with the rest of the TCE strategist teams to make sure that they are appropriate and sufficient. It is appreciated that the action steps table 700 may be also be utilized by the goal owners during the action planning of step 308 but before the alignment session. As such, the completely filled out action steps table 700 may be brought by the goal owners to the alignment session which may be reviewed with the rest of the TCE strategist teams to make sure that they are appropriate and sufficient.

It is understood that the action planning process of step 308 of FIG. 3 may be performed utilizing a computer (e.g., 100a) and/or other computers (e.g., 100b-100d) via a network (e.g., 200). For example, a video teleconferencing of the action planning of step 308 may be conducted via network 200 in order to include remote general managers and their team members that may be unable to meet at a particular location. Furthermore, within another embodiment of the present invention, data and information associated with the action planning of step 308 may be transmitted and received (e.g., via e-mail) between general managers and their team members that are unable to participate as part of the action planning process.

At step 310 of FIG. 3, within the present embodiment, a taking action process is implemented wherein action plans are implemented in order to achieve the TCE goals. Within the taking action process of step 310, the progress is measured and tracked against the previously specified success criteria and customer data. Additionally, during the taking action process, on-going consultation by those familiar with the TCE action planning process 300 may be provided as needed in areas such as: customer experience planning and design, value delivery system analysis and mapping, and customer satisfaction and loyalty measurement and analysis. It should be understood that within the present embodiment of step 310, the objectives of the taking action process may be to focus on implementing the action plans along with measuring and tracking the progress of the department(s) in performing those action plans.

Specifically, during the taking action process of step 310, the action plans are implemented in order to efficiently achieve the improvement goals. Additionally, during the taking action process of step 310, the progress of the action plans are measured and tracked against the pre-established success criteria. Furthermore, during the taking action process, the progress of the goals are measured and tracked against the customer TCE loyalty and satisfaction measurements. It should be pointed out that there are two levels of measuring and tracking involved within the taking action process of step 310. At one level there is the measuring and tracking process of action plans against success criteria at a local basis. At another level, there is the continuation of measuring and monitoring the data that was used during the strategy session of step 306 that initially drove the TCE strategist to set their goals in order to make sure that these implementations have had the desired impact at that level that they thought they would.

It is understood that the taking action process of step 310 of FIG. 3 may be performed utilizing a computer (e.g., 100a) and/or other computers (e.g., 100b-100d) via a network (e.g., 200). For example, data and information associated with the taking action process of step 310 may be transmitted (e.g., via e-mail) to those involved with implementing the action plans along with measuring and tracking the progress of the pre-established success criteria and the like.

It should be appreciated that there will be some cycle time with the TCE action planning process of flowchart 300. For example, whatever cycle time makes sense for the business cycle of the organization, it should periodically revisit the TCE action planning process 300. Therefore, at some point after the taking action process of step 310, the organization returns to the data gathering of step 304 in order to repeat steps 304-310. By returning to the data gathering of step 304, the organization is able determine their current TCE performance after one cycle through the TCE action planning process 300. Therefore, the organization is then able to go through another data gathering process of step 304 in order to figure out where they are at in providing a superior customer experience. Subsequently during the TCE action planning process 300, the insights and conclusion derived from the data gathering process may be utilized to determine what high leverage improvement goals the organization should set at that point in time.

Accordingly, the present invention provides a method and system for providing a solution that is able to remedy some of the disadvantages associated with large scale business organizations. Specifically, the present invention provides a method and system for enabling a large scale business organization to determine whether they are providing a satisfactory level of service and/or products to their customers. Furthermore, the present invention also provides a method and system which satisfies the above accomplishment and is based on objectivity instead of subjectivity. Additionally, the present invention also provides a method and system which satisfies the above accomplishments and also includes accountability for those involved with it. The present invention also provides a method and system which satisfies the above accomplishments and is properly implemented because leadership (e.g., organizational, departmental, and the like) is involved with it. Moreover, the present invention also provides a method and system which satisfies the above accomplishments and has the organization's leadership providing support and resources to those involved with it.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for implementing a total customer experience action planning process to provide an improved customer experience, said method comprising:
(a) gathering data associated with an organization and customers of said organization;
(b) during a strategy session associated with said organization, determining a goal for said organization along with an associated success metric for accomplishing said goal, wherein said goal is based on said data;
(c) determining a department goal along with an associated success metric for accomplishing said department goal, wherein said department goal is closely associated with a business objective of said organization; and
(d) taking measurable action to accomplish said department goal.

2. The method as described in claim 1 further comprising:
(e) during a commitment session associated with said organization, providing an overview of said total customer experience action planning process to a manager of said organization and to staff associated with said manager.

3. The method as described in claim 1 wherein said data further comprises data provided by a partner organization that works together with said organization.

4. The method as described in claim 1 wherein said data further comprises data provided by managers associated with said organization.

5. The method as described in claim 1 further comprising:
(e) repeating said (a) through (d) at some future time.

6. The method as described in claim 1 wherein said (c) further comprises:
(c1) verifying said department goal and said associated success metric for accomplishing said department goal within an up-line manager of said organization.

7. A computer readable medium having computer readable code embodied therein for causing a computer to perform:
(a) receiving data associated with an organization and customers of said organization;
(b) during a strategy session associated with said organization, receiving a goal for said organization along with an associated success metric for accomplishing said goal, wherein said goal is based on said data;
(c) receiving a department goal along with an associated success metric for accomplishing said department goal, wherein said department goal is closely associated with a business objective of said organization; and
(d) receiving measurable action taken to accomplish said department goal.

8. The computer readable medium as described in claim 7 further comprising:
(e) during a commitment session associated with said organization, providing an overview of said total customer experience action planning process to a manager of said organization and to staff associated with said manager.

9. The computer readable medium as described in claim 7 wherein said data further comprises data provided by a partner organization that works together with said organization.

10. The computer readable medium as described in claim 7 wherein said data further comprises data provided by managers associated with said organization.

11. The computer readable medium as described in claim 7 further comprising:
(e) repeating said (a) through (d) at some future time.

12. The computer readable medium as described in claim 7 wherein said (c) further comprises:
(c1) transmitting said department goal and said associated success metric for accomplishing said department goal to an up-line manager of said organization for a verification.

13. The computer readable medium as described in claim 12 wherein said (c) further comprises:
(c2) receiving said verification from said up-line manager of said organization.

14. A computer system comprising:
a processor;
an addressable data bus coupled to said processor; and
a memory device coupled to communicate with said processor for implementing a total customer experience action planning process, said method comprising:
(a) receiving data associated with an organization and customers of said organization;
(b) during a strategy session associated with said organization, receiving a goal for said organization along with an associated success metric for accomplishing said goal, wherein said goal is based on said data;
(c) receiving a department goal along with an associated success metric for accomplishing said department goal, wherein said department goal is closely associated with a business objective of said organization; and
(d) receiving measurable action taken to accomplish said department goal.

15. The computer system as described in claim 14 wherein said method further comprising:
(e) during a commitment session associated with said organization, providing an overview of said total customer experience action planning process to a manager of said organization and to staff associated with said manager.

16. The computer system as described in claim 14 wherein said data further comprises data provided by a partner organization that works together with said organization.

17. The computer system as described in claim 14 wherein said data further comprises data provided by managers associated with said organization.

18. The computer system as described in claim 14 wherein said method further comprising:
(e) repeating said (a) through (d) at some future time.

19. The computer system as described in claim 14 wherein said (c) further comprises:
(c1) transmitting said department goal and said associated success metric for accomplishing said department goal to an up-line manager of said organization for a verification.

20. The computer system as described in claim 19 wherein said (c) further comprises:
(c2) receiving said verification from said up-line manager of said organization.
